(19) United States
(12) Patent Application Publication
(10) Pub. No.: US 2012/0106972 A1
(43) Pub. Date: May 3, 2012

(54) UNIVERSAL REMOTE CONTROL

(75) Inventor: YUNG-LUNG LIU, Ta Ya Shiang (TW)

(73) Assignee: Sunrex Technology Corp., Ta Ya Shiang (TW)

(21) Appl. No.: 12/915,334

(22) Filed: Oct. 29, 2010

(51) Int. Cl. H04B 10/04

(52) U.S. Cl. 398/112

(57) ABSTRACT

A universal remote control includes a hand held housing; a plurality of button zones provided on a substantial portion of a top surface of the housing, each button zone comprising a plurality of pushbuttons each having a character printed thereon; a control assembly partially exposed on the housing and comprising a Bluetooth module, a laser module, a pointer control module, an IR module, an RF module, a control unit electrically connected to each of the modules for controlling its operations, and a switch for manually activating the control unit; and a battery provided in the housing for supplying power to the control assembly. In responses to generating a signal by pressing the pushbutton, the control unit receives the signal and sends same to one of the IR module, the RF module, the Bluetooth module, and the laser module for transmission.

### BACKGROUND OF THE INVENTION

1. Field of Invention

The invention relates to remote controls and more particularly to a universal remote control with improved characteristics.

2. Description of Related Art

A remote control is a component of an electronics device for operating the device wirelessly from a short line-of-sight distance. Remote controls for televisions, stereo systems, or DVD (Digital Video Disc) players are typically small wireless handheld objects having an array of push buttons for adjusting various settings such as television channel, track number, and volume. Most remote controls communicate to their respective devices via infrared (IR) signals.

There is a type of remote control capable of operating multiple electronic devices commercially available. Advantage of this remote control is that it can learn remote signals from different devices. It has the ability to perform specific or multiple functions at various times with its built-in clock. Also, it can be linked to a computer and loaded with updated software code as needed.

Recently, the number of consumer electronic devices in most homes is greatly increased, along with the number of remotes to control those devices. Typically, one remote control is for one consumer electronic device. For example, to operate a home theater as many as five remotes may be required, including one for cable or satellite receiver, or DVD player. Several of these remotes may need to be used sequentially but, as there are no accepted interface guidelines, the process is increasingly cumbersome. To the worse, it is very confusing and unwieldy and may easily frustrate users. Nowadays, a type of universal remote controls capable of managing multiple devices is becoming increasingly popular.

Most mice and keyboards are connected to computers by wire. However, distance between, for example, a mouse and a computer is limited due to the limitation of the cable length. There are wireless mice and keyboards commercially available. However, its cost is relatively high. Thus, the need for a universal remote control still exists.

### SUMMARY OF THE INVENTION

It is therefore one object of the invention to provide a universal remote control comprising a hand held housing; a plurality of button zones provided on a substantial portion of a top surface of the housing, each button zone comprising a plurality of pushbuttons each having a character printed thereon; a control assembly partially exposed on the housing and comprising a Bluetooth module, a laser module, a pointer control module, an IR module, an RF module, a control unit electrically connected to each of the modules for controlling its operations, and a switch for manually activating the control unit; and a battery provided in the housing for supplying power to the control assembly, wherein in responses to generating a signal by pressing the pushbutton, the control unit receives the signal and sends same to one of the IR module, the RF module, the Bluetooth module, and the laser module for transmission.

The above and other objects, features and advantages of the invention will become apparent from the following detailed description taken with the accompanying drawings.

### BRIEF DESCRIPTION OF THE DRAWINGS

FIG. 1 is a perspective view of a universal remote control according to a first preferred embodiment of the invention;

FIG. 2 is a block diagram of a control assembly of the remote control of FIG. 1;

FIG. 3 is a perspective view of the vibratory double axially sensing micro-gyroscope of FIG. 2;

FIG. 4 is a perspective view of a universal remote control according to a second preferred embodiment of the invention;

FIG. 5 is a block diagram of a control assembly of the remote control of FIG. 4;

FIG. 6 is a longitudinal sectional view of the trackball of FIG. 5;

FIG. 7 is a perspective view of a universal remote control according to a third preferred embodiment of the invention;

FIG. 8 is a block diagram of a control assembly of the remote control of FIG. 7; and

FIG. 9 is a longitudinal sectional view of the OFN of FIG. 8.

### DETAILED DESCRIPTION OF THE INVENTION

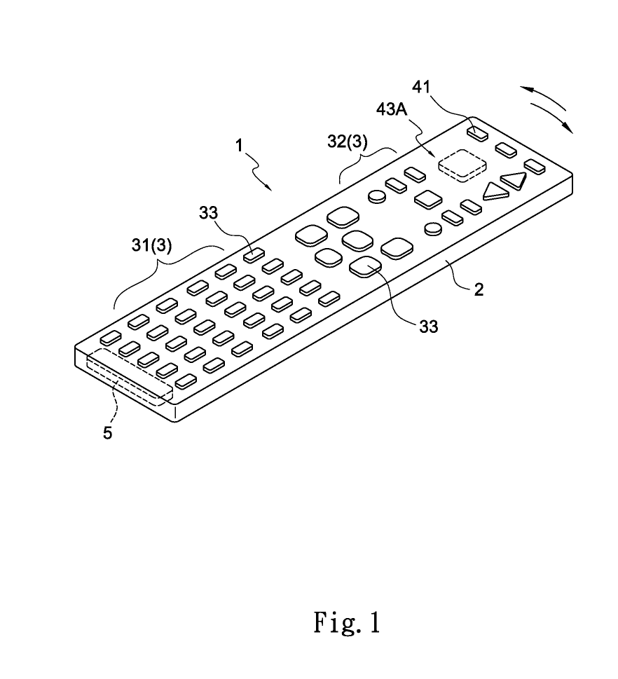

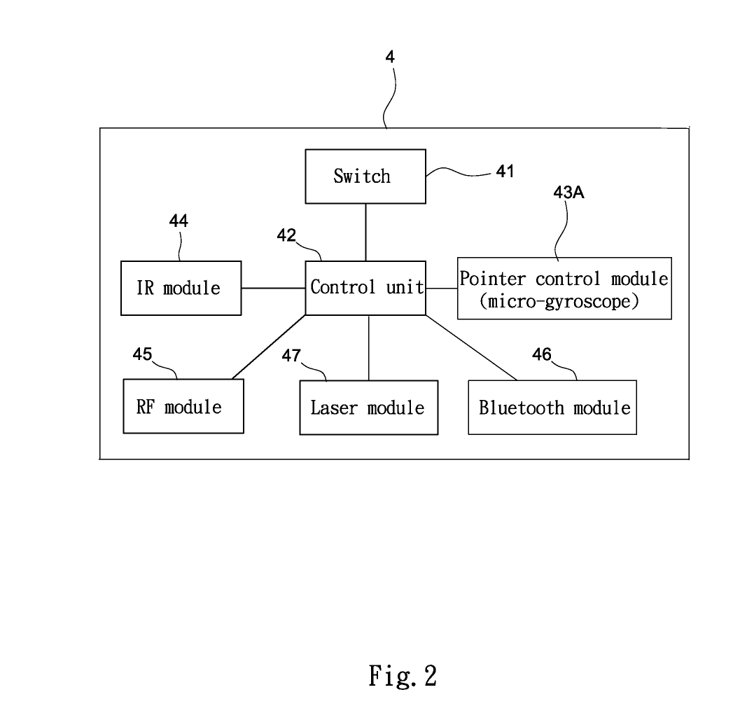

Referring to FIGS. 1 to 3, a universal remote control 1 in accordance with a first preferred embodiment of the invention comprises the following components as discussed in detail below.

A rectangular, thin profile housing 2 is adapted to be held by the hand. Preferably, the housing 2 is ergonomic for ease of holding by the hand.

A plurality of (e.g., two as shown) button zones 3 are provided on a substantial portion of top surface of the housing 2. Each button zone 3 comprises a plurality of pushbuttons 33 each having a character printed thereon. Alternatively, each button zone 3 is implemented as a touch pad (not shown) having a plurality of virtual keys (not shown). The pushbuttons 33 are provided either on an alphanumeric keypad (similar to a computer keyboard) 31 or an equipment and operation selecting section 32.

A control assembly 4 comprises a Bluetooth module 46 adapted to communicate with a personal computer (PC) wirelessly. Hence, a user may press one of the pushbuttons 33 on the keypad 31 to send a signal to the computer for data input similar to the typical keyboarding.

The equipment and operation selecting section 32 can communicate to respective devices (e.g., televisions, stereo systems, or DVD players (all not shown)) via infrared (IR) signals or radio frequency (RF) signals.

The control assembly 4 has a portion exposed on the housing 2. The control assembly 4 comprises, in addition to the Bluetooth module 46, a laser module 47, a pointer control module, an IR module 44, an RF module 45, a control unit 42 electrically connected to each of the above components for controlling its operation, and a switch 41 for manually activating the control unit 42 or not.

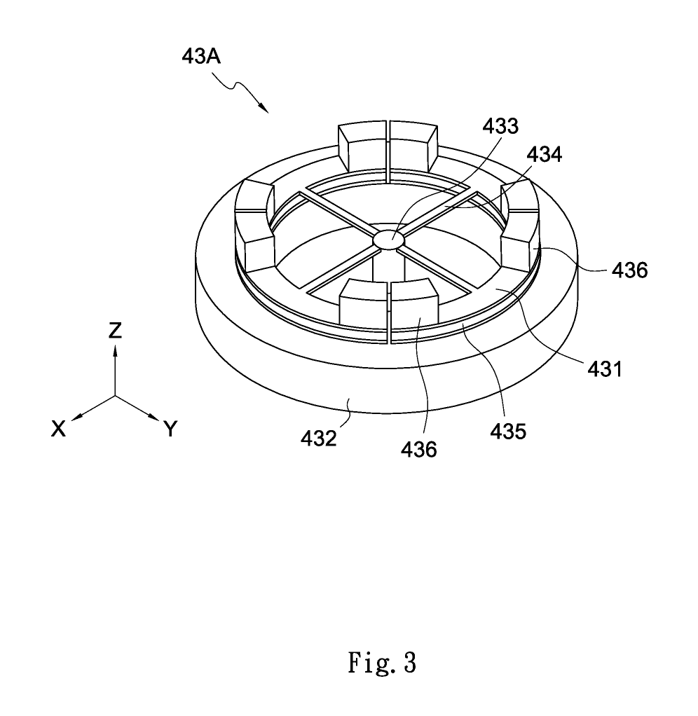

In the embodiment, the pointer control module is provided within the housing 2 and implemented as a vibratory double axially sensing micro-gyroscope 43A driven by static-electricity and sensed by capacitance. The vibratory double axially sensing micro-gyroscope 43A is provided on an integrated circuit (IC) in the housing 2 and comprises a ring shaped base 432, a supporting hub 433 on a center of the base 432, a plurality of (preferably the number being a multiple of two with four shown in FIG. 3) equally spaced suspending arms 434 extending horizontally out of the supporting hub 433, an arc shaped platform 431 having a center formed with an outer end of each of the suspending arms 434 (i.e., forming a discontinuous ring shape), a plurality of (four are shown) static electricity driving electrodes 435 each sandwiched between the upper platform 431 and the base 432, and two metallic capacitance sensing electrodes 436 formed on tops of both ends of each platform 431 respectively (i.e., eight metallic capacitance sensing electrodes 436). The capacitance sensing electrode 436 is formed on the platform 431 by micro-electroplating technique. The vibratory double axially sensing micro-gyroscope 43A employs the capacitance sensing electrodes 436 as an inertia weight.

When the static electricity driving electrodes 435 are activated by applying voltage thereto, the suspending arms 434 and the platforms 431 are attracted by static electricity to vibrate in Z direction. Vibration phase difference between two adjacent suspending arms 434 is 180 degrees and that between two adjacent platforms 431 is also 180 degrees. When the vibratory double axially sensing micro-gyroscope 43A rotates in X direction or Y direction, the suspending arms 434 and the platforms 431 displace in X direction or Y direction due to Coriolis effect. The capacitance sensing electrodes 436 will generate different capacitances because distance between one capacitance sensing electrode 436 on one platform 431 and the other capacitance sensing electrode 436 on the adjacent platform 431 is changed. Angular speed or angular acceleration of the vibratory double axially sensing micro-gyroscope 43A can be obtained by measuring the change of capacitances.

The switch 41 can be pressed to activate one of the IR module 44, the RF module 45, the Bluetooth module 46, and the laser module 47 via the control unit 42. A signal is generated by pressing a pushbutton 33 on the button zone 3. Then the control unit 42 receives the signal and sends same to one of the IR module 44, the RF module 45, the Bluetooth module 46, and the laser module 47 for transmission.

For example, the switch 41 can be pressed to enable the IR module 44 or the RF module 45 so that a user may hold the remote control 1 to activate a TV, a DVD player, or a projector. Alternatively, the switch 41 can be pressed to enable the Bluetooth module 46 so that the user may hold the remote control 1 to communicate with a PC and send data thereto by pressing the pushbuttons 33 on the keypad 31. Still alternatively, the switch 41 can be pressed to enable the laser module 47 to cause the remote control 1 to project laser light to a target. For controlling movement of a cursor or a pointer, the user may use the hand to move or rotate the remote control 1 to achieve the goal because the pointer control module is implemented as a vibratory double axially sensing micro-gyroscope 43A in the embodiment.

It is contemplated that the remote control 1 can be used a universal (i.e., multi-function) remote control by configuring the invention as above.

Moreover, a battery 5 is provided within the housing 2 for supplying power to the control assembly 4.

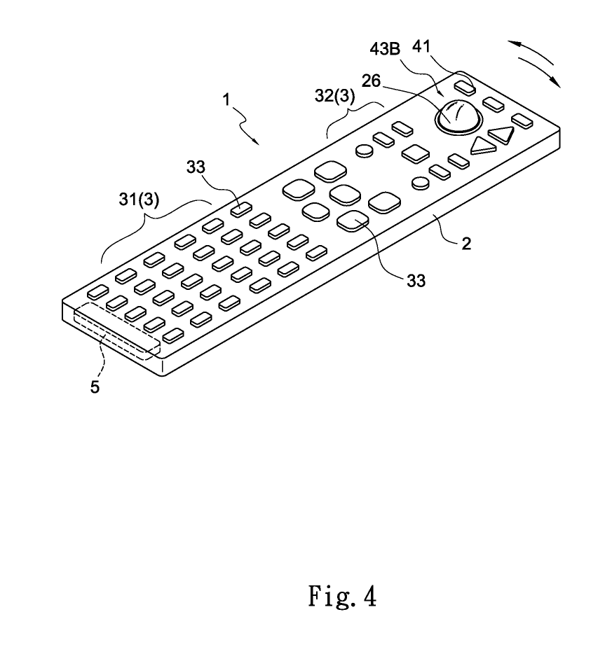

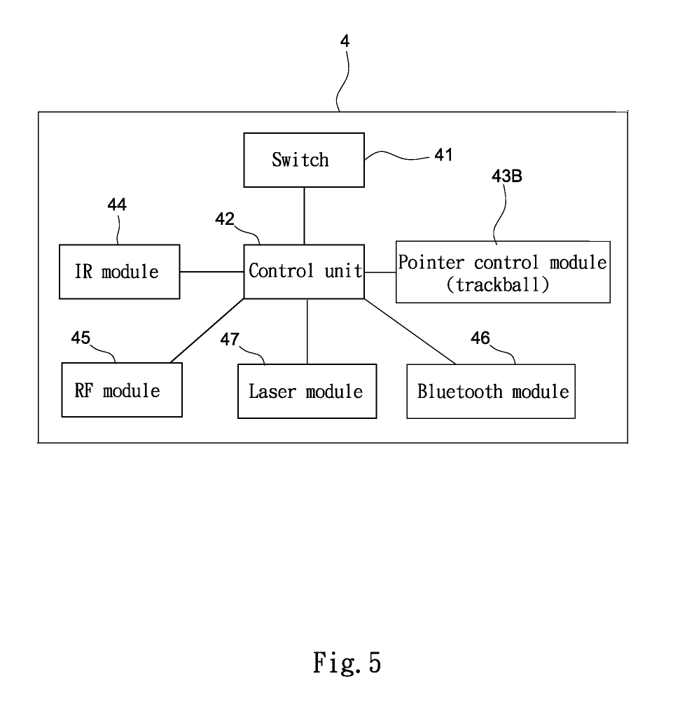

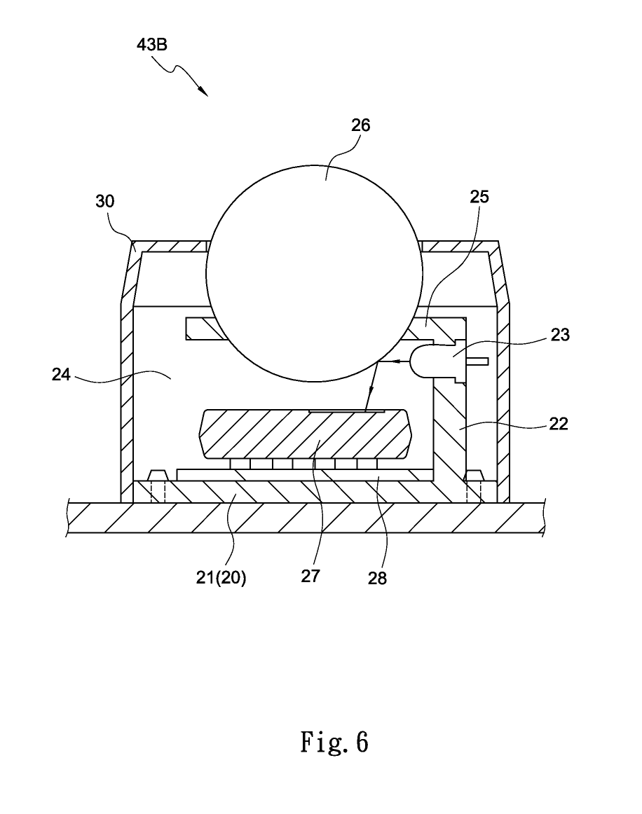

Referring to FIGS. 4 to 6, a universal remote control 1 in accordance with a second preferred embodiment of the invention comprises the following components as discussed in detail below. The characteristics of the second preferred embodiment are substantially the same as that of the first preferred embodiment except the following:

The pointer control module is implemented as a trackball 43B comprising a base 20, a laser source generator 23, a locus ball 26, a light sensing element 27, and a key cover 30 each discussed in detail below.

A laser module 47 and a light sensing module (not shown) are provided in the base 20. Bottom plate 21 of the base 20 is fastened on the housing 2. The laser source generator 23 is provided in a locating hole (not numbered) formed in one of a plurality of lateral plates 22. The locus ball 26 is moveably received in and supported by a supporting bore (not numbered) on a top plate 25 of the base 20. The supporting bore has an annular edge diverging upward and the edge has the same curvature as the locus ball 26. A space 24 is defined between the top plate 25 and the bottom plate 21 in the base 20. The light sensing element 27 is disposed in the space 24. The laser source generator 23 is a semiconductor laser diode for projecting a laser light. The laser source generator 23 is lightweight, compact, low in power consumption, and energy saving. Further, the laser source generator 23 is capable of emitting light with single color and frequency. Light impinged on an interference strip figure of the locus ball 26 may be reflected to the light sensing element 27 for analysis and calculation. As a result, direction and movement of the locus ball 26 can precisely obtained. The locus ball 26 is partially exposed on the supporting bore and has a lower portion hidden by the base 20 and facing the laser source generator 23. The locus ball 26 has a diameter about 5 mm.

The light sensing element 27 can capture light reflected by the locus ball 26 and generate a control signal to indicate direction and movement of the locus ball 26. A cursor on the computer screen may move in response to the direction and movement of the moving locus ball 26. The key cover 30 is shaped to cover the base 20 completely and has an annular hole on the top to permit an upper portion of the locus ball 26 to extend outward through. Thus, a user may rotate the locus ball 26 to move the cursor toward a desired position on the computer screen.

It is contemplated that the remote control 1 can be used a universal (i.e., multi-function) remote control by configuring the invention as above.

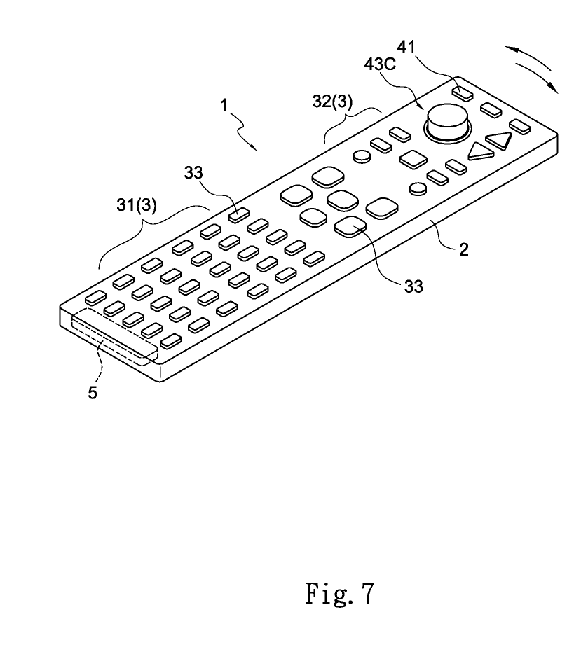

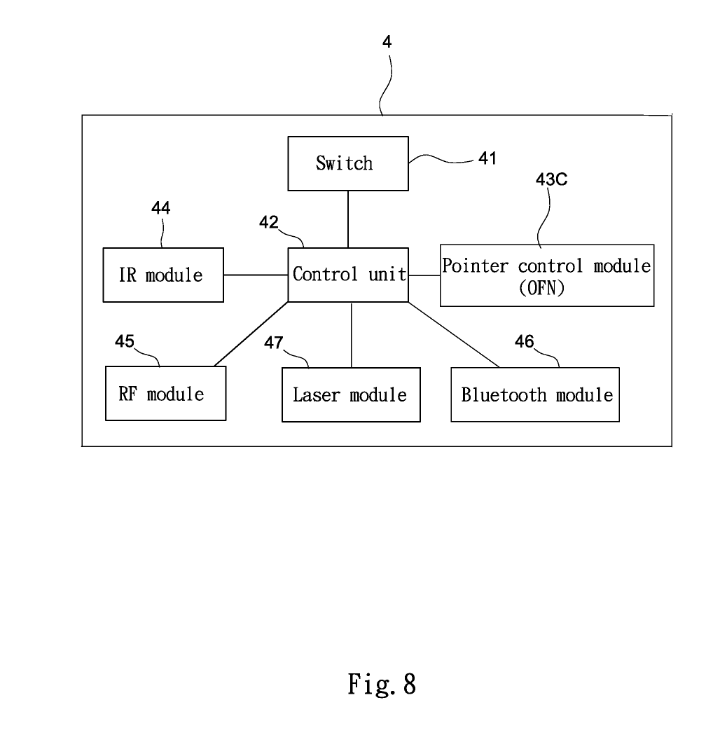

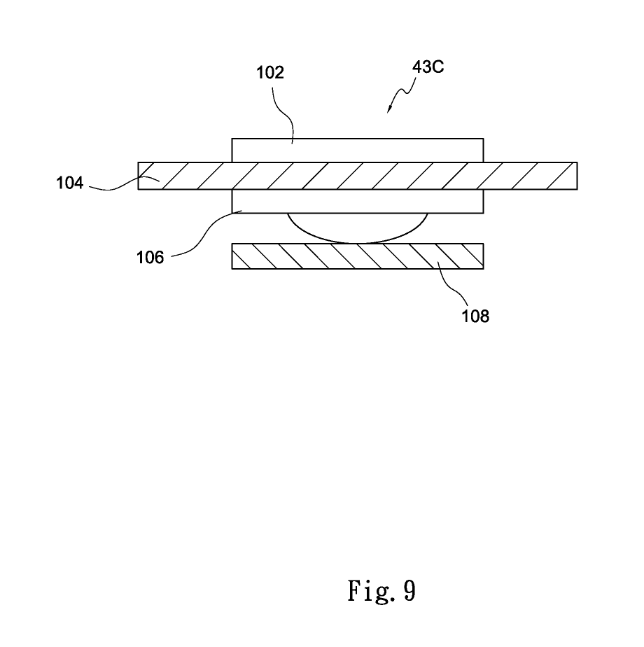

Referring to FIGS. 7 to 9, a universal remote control in accordance with a third preferred embodiment of the invention comprises the following components as discussed in detail below. The characteristics of the third preferred embodiment are substantially the same as that of the first preferred embodiment except the following: The pointer control module is implemented as an optical finger navigation (OFN) 43C partially exposed on the housing 2. The OFN 43C comprises a printed circuit board (PCB) 104, an optical sensor 102 on top of the PCB 104, a tactile switch 106 on the underside of the PCB 104, and a surface 208 under the switch 106 as detailed below.

The optical sensor 102 comprises a light source and a pixel array for capturing pattern of a moving image.

Alternatively, the PCB 104 is replaced with a flexible PCB (FPCB) having increased flexibility.

The PCB 104 comprises a pair of side circuit boards each having at least one component which is electrically connected to the PCB 104.

The optical sensor 102 is adhered to a die pad encapsulated by a lead frame. The optical sensor 102 can sense the presence of the hand by a distance which can be relatively long, short, or therebetween in use. After sensing the presence of the hand, the optical sensor 102 can generate a signal for indication.

It is contemplated that the remote control 1 can be used a universal (i.e., multi-function) remote control by configuring the invention as above.

While the invention has been described in terms of preferred embodiments, those skilled in the art will recognize that the invention can be practiced with modifications within the spirit and scope of the appended claims.

What is claimed is:

1. A universal remote control comprising:
a hand held housing;
a plurality of button zones provided on a substantial portion of a top surface of the housing, each button zone comprising a plurality of pushbuttons each having a character printed thereon;
a control assembly partially exposed on the housing and comprising a Bluetooth module, a laser module, a pointer control module, an infrared (IR) module, a radio frequency (RF) module, a control unit electrically connected to each of the modules for controlling its operations, and a switch for manually activating the control unit; and
a battery provided in the housing for supplying power to the control assembly,
wherein in responses to generating a signal by pressing the pushbutton, the control unit receives the signal and sends same to one of the IR module, the RF module, the Bluetooth module, and the laser module for transmission.

2. The universal remote control of claim 1, wherein the pointer control module is disposed in the housing and is a vibratory double axially sensing micro-gyroscope comprising a ring shaped base, a supporting hub on a center of the base, a plurality of equally spaced suspending arms extending horizontally out of the supporting hub, an arc shaped platform having a center formed with an outer end of each of the suspending arms, a plurality of static electricity driving electrodes each sandwiched between the platform and the base, and two metallic capacitance sensing electrodes formed on tops of both ends of each platform respectively.

3. The universal remote control of claim 1, wherein the pointer control module is a trackball comprising a base, a laser source generator, a locus ball, a light sensing element, and a key cover, and wherein the laser module and a light sensing module are provided in the base, a bottom plate of the base is fastened on the housing, the laser source generator is provided in a locating hole formed in one of a plurality of lateral plates, the locus ball is moveably received in and supported by a supporting bore on a top plate of the base, a space is defined between the top plate and the bottom plate in the base, the light sensing element is disposed in the space, the laser source generator is a semiconductor laser diode for projecting a laser light on the locus ball and being reflected to the light sensing element, and the locus ball is partially exposed on the supporting bore and has a lower portion hidden by the base and facing the laser source generator.

4. The universal remote control of claim 1, wherein the pointer control module is an optical finger navigation (OFN) partially exposed on the housing, the OFN comprising a printed circuit board (PCB), an optical sensor on the top of the PCB, a tactile switch on the underside of the PCB, and a surface under the switch, and wherein the optical sensor comprises a light source and a pixel array for capturing pattern of a moving image, the PCB comprises a pair of side circuit boards each having at least one component which is electrically connected to the PCB, the optical sensor is adhered to a die pad encapsulated by a lead frame, and the optical sensor can sense the presence of the hand so that after sensing the presence of the hand, the optical sensor can generate a signal for indication.

5. The universal remote control of claim 1, wherein a first one of the button zones is an alphanumeric keypad.

6. The universal remote control of claim 1, wherein a second one of the button zones is an equipment and operation selecting section for communicating to a respective one of devices including a television, a stereo system, and a Digital Video Disc (DVD) player.

7. The universal remote control of claim 1, wherein the Bluetooth module is adapted to communicate with a personal computer (PC) wirelessly.

8. The universal remote control of claim 1, wherein each of the button zones is a touch pad having a plurality of virtual keys.
